(19) United States
(12) Patent Application Publication
(10) Pub. No.: US 2013/0329140 A1
(43) Pub. Date: Dec. 12, 2013

(54) SYSTEM AND METHOD FOR PROVIDING MULTIPLE MULTIMEDIA ACTIVITIES ON MULTIPLE OUTPUT DEVICES

(71) Applicants: Gary Jefferson Silverberg, Toronto (CA); Blake Benjamin Thomas Southey, Mississauga (CA); Alexander Gerald Christian Hess, Toronto (CA)

(72) Inventors: Gary Jefferson Silverberg, Toronto (CA); Blake Benjamin Thomas Southey, Mississauga (CA); Alexander Gerald Christian Hess, Toronto (CA)

(73) Assignee: SILVERBERG LINE CANADA INC., Toronto (CA)

(21) Appl. No.: 13/489,952

(22) Filed: Jun. 6, 2012

(51) Int. Cl. H04B 10/10; H04N 5/44

(52) U.S. Cl. 348/734; 348/E05.096

(57) ABSTRACT

A method and system are provided for providing first and second activities using multimedia devices. This involves linking each of the first and second activities with an output multimedia device by creating an activity profile for each output multimedia device being linked, the activity profile is associated with a profile identifier for that output multimedia device, activity multimedia devices for providing that activity and initialization commands for initiating that activity; receiving, from a control device, control signals for initiating the first and second activities, each control signal includes a profile identifier for identifying an activity profile and a target output multimedia device; determining initialization commands and activity multimedia devices for initiating the first and second activities based on the activity profiles associated with the profile identifiers; and providing the first and second activities on the corresponding target output multimedia devices by sending the initialization commands to the activity multimedia devices.

### FIELD

The described embodiments relate to a system and method for providing multimedia activities. The system and method, in some embodiments, are directed to providing multiple multimedia activities using multiple multimedia devices.

### BACKGROUND

A multimedia center generally includes an output device, such as a display, and various other multimedia devices for providing a multimedia activity. Conventionally, the devices in the multimedia center are used to provide one activity. However, as a greater variety of multimedia devices become available and as technology become increasingly integrated in daily routines, it may be inconvenient and inefficient for only one activity to be provided by the multimedia devices, that is, for only one display to be active at one time. In particular, if the multimedia center is located within a shared space, different users, while together in that shared space, may be interested in engaging in different activities associated with the various multimedia devices. This may be especially important for smaller living areas.

There is, thus, a need for multiple multimedia activities to be provided on multiple output devices in order to maximize usage of the multimedia devices.

### SUMMARY

In accordance with an aspect of an embodiment of the invention, there is provided a method of providing first and second activities using a plurality of multimedia devices. The method comprising linking each of the first and second activities with at least one output multimedia device by creating an activity profile for each output multimedia device being linked, the activity profile being associated with a profile identifier for that output multimedia device, one or more activity multimedia devices for providing that activity and initialization commands for initiating that activity, wherein at least one initialization command is an infrared (IR) command; receiving, from a control device, first and second control signals for initiating the first and second activities, each control signal comprising a profile identifier for identifying an activity profile and a target output multimedia device; determining the initialization commands and the activity multimedia devices for initiating the first and second activities based on the activity profiles associated with the profile identifiers provided in the received first and second control signals; and providing each of the first and second activities on the corresponding target output multimedia device by sending the determined initialization commands to the activity multimedia devices, wherein the IR commands of the determined initialization commands are sent via an IR emitting device and the remaining initialization commands of the determined initialization commands are sent via a matrix module.

In accordance with an embodiment of the invention, there is provided a system of providing first and second activities using a plurality of multimedia devices. The system comprising a memory module operable to store a plurality of activity profiles for a plurality of output multimedia devices, each activity profile being associated with a profile identifier for a corresponding output multimedia device, one or more activity multimedia devices for providing that activity and initialization commands for initiating that activity, wherein at least one initialization command is an infrared (IR) command; an interface module operable to receive, from a control device, first and second control signals for initiating the first and second activities, each control signal comprising a profile identifier for identifying an activity profile and a target output multimedia device; and a processor module operable to link each of the first and second activities with at least one output multimedia device by creating an activity profile for each output multimedia device being linked; determine the initialization commands and the activity multimedia devices for initiating the first and second activities based on the activity profiles associated with the profile identifiers provided in the received first and second control signals; and provide each of the first and second activities on the corresponding target output multimedia device by sending initialization commands to activity multimedia devices, wherein the IR commands of the determined initialization commands are sent via an IR emitting device and the remaining initialization commands of the determined initialization commands are sent via a matrix module.

In accordance with an aspect of an embodiment of the invention, there is provided a method of providing first and second activities using a plurality of multimedia devices. The method comprising linking each of the first and second activities with at least one output multimedia device by creating an activity profile for each output multimedia device being linked, the activity profile being associated with a profile identifier for that output multimedia device, one or more activity multimedia devices for providing that activity and initialization commands for initiating that activity, wherein at least one initialization command is a device command for operating an activity multimedia device; receiving, from a control device, first and second control signals for initiating the first and second activities, each control signal comprising a profile identifier for identifying an activity profile and a target output multimedia device; determining the initialization commands and the activity multimedia devices for initiating the first and second activities based on the activity profiles associated with the profile identifiers provided in the received first and second control signals; and providing each of the first and second activities on the corresponding target output multimedia device by sending the determined initialization commands to the activity multimedia devices, wherein the device commands of the determined initialization commands are sent via an emitter unit and the remaining initialization commands of the determined initialization commands are sent via a matrix module.

In accordance with an embodiment of the invention, there is provided a system of providing first and second activities using a plurality of multimedia devices. The system comprising a memory module operable to store a plurality of activity profiles for a plurality of output multimedia devices, each activity profile being associated with a profile identifier for a corresponding output multimedia device, one or more activity multimedia devices for providing that activity and initialization commands for initiating that activity, wherein at least one initialization command is a device command for operating an activity multimedia device; an interface module operable to receive, from a control device, first and second control signals for initiating the first and second activities, each control signal comprising a profile identifier for identifying an activity profile and a target output multimedia device; and a processor module operable to link each of the first and second activities with at least one output multimedia device by creating an activity profile for each output multimedia device being linked; determine the initialization commands and the activity multimedia devices for initiating the first and second activities based on the activity profiles associated with the profile identifiers provided in the received first and second control signals; and provide each of the first and second activities on the corresponding target output multimedia device by sending initialization commands to activity multimedia devices, wherein the device commands of the determined initialization commands are sent via an emitter unit and the remaining initialization commands of the determined initialization commands are sent via a matrix module.

### BRIEF DESCRIPTION OF THE DRAWINGS

A preferred embodiment of the present invention will now be described in detail with reference to the drawings, in which:

FIG. 1 is a block diagram of a multimedia network for providing first and second activities using multiple activity multimedia devices, in accordance with an embodiment of the present disclosure;

FIGS. 2A and 2B are diagrams illustrating an example multimedia network of FIG. 1 for providing first and second activities using a plurality of activity multimedia devices, in accordance with an embodiment of the present disclosure;

FIG. 3 is a flowchart diagram illustrating the steps of providing first and second activities using a plurality of activity multimedia devices, in accordance with an embodiment of the present disclosure;

FIG. 4 is a screenshot of an example user interface for configuring multimedia devices, in accordance with an embodiment of the present disclosure; and

FIG. 5 is a screenshot of an example user interface for identifying a multimedia device, in accordance with an embodiment of the present disclosure;

FIG. 6 is a screenshot of an example user interface for associating activities with a multimedia device, in accordance with an embodiment of the present disclosure;

FIG. 7 is a screenshot of an example user interface for indicating how a multimedia device receives initialization commands, in accordance with an embodiment of the present disclosure;

FIGS. 8 and 9 are screenshots of example user interfaces for configuring a remote profile for a multimedia device, in accordance with an embodiment of the present disclosure;

FIG. 10 is a screenshot of an example user interface for designing a remote interface for a multimedia device, in accordance with an embodiment of the present disclosure;

FIG. 11 is a screenshot of an example user interface for linking activities with output multimedia devices, in accordance with an embodiment of the present disclosure; and

FIG. 12 is an illustration of an example user interface of an example control device, in accordance with an embodiment of the present disclosure.

### DESCRIPTION OF EXEMPLARY EMBODIMENTS

The embodiments of the processes and methods described herein may be implemented in hardware or software, or a combination of both. Alternatively, these embodiments may also be implemented in computer programs executed on programmable computers each comprising at least one processor module (e.g., a microprocessor), a memory module (including volatile and non-volatile memory and/or storage elements), and an interface module (including at least one input device and at least one output device). For example and without limitation, the programmable computers (referred to below as computing devices) may be a personal computer, laptop, personal data assistant, cellular telephone, smart-phone device, tablet computer, set-top boxes and/or wireless device. For any software components, program code is applied to input data to perform the functions described herein and generate output information. The output information is applied to one or more output devices, in known fashion.

Each software component or program may be implemented in a high level procedural or object oriented programming and/or scripting language to communicate with a computer system. However, the programs may be implemented in assembly or machine language, if desired. In any case, the language may be a compiled or interpreted language. Each such computer program is preferably stored on a storage media or a device (e.g. ROM) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

The various embodiments described herein generally relate to a system and method for providing a first and a second multimedia activity using a plurality of multimedia devices. A multimedia activity may be, for example, watching a television program, playing video games, and other similar activities. Each of the first and second activities may be linked with an output multimedia device by creating an activity profile for the output multimedia device being linked. Example output multimedia devices include a television display, a projector monitor and other similar devices.

Generally, the activity profile provides the information needed for initiating a multimedia activity on a linked multimedia device. The activity profile may be associated with a profile identifier that uniquely identifies the linked output multimedia device, one or more activity multimedia devices for providing that activity and initialization commands for initiating that activity. The first and second multimedia activity may be initiated after the control system receives, from a control device, a first and a second control signal.

Each control signal includes a profile identifier for identifying an activity profile and a target output multimedia device. Since each activity profile is linked with an output multimedia device, the control system may determine the initialization commands and the activity multimedia devices for initiating the first and second multimedia activities by using the received control signals for identifying the selected activity profiles. The control system may then provide the first and the second multimedia activity on the target output multimedia devices.

By enabling multiple multimedia activities to be provided using a control device, the control system may enable a more flexible and convenient multimedia experience. For example, a user may want to multitask and be able to easily conduct different multimedia activities using a control device. Alternatively, different users may want to share a common area where the multimedia devices are located, while also conducting their respective multimedia activities. An example may include members of a family who want to be in each other's company but who also want to engage in different multimedia activities. Another example may be parents who are enjoying a movie on one display linked to a DVD player, while their child works on a homework assignment on another display linked to a personal computer. With this configuration, the parents may enjoy their movie while helping with and monitoring their child's work.

This control system may be particularly helpful if the living area is a small space so that both the multimedia devices and space may be maximized. Furthermore, as smart computing devices, such as smart phones and tablet computers, become more prevalent, the ability for any networked smart computing device to access the control system for providing multiple multimedia activities may offer substantial convenience to the users.

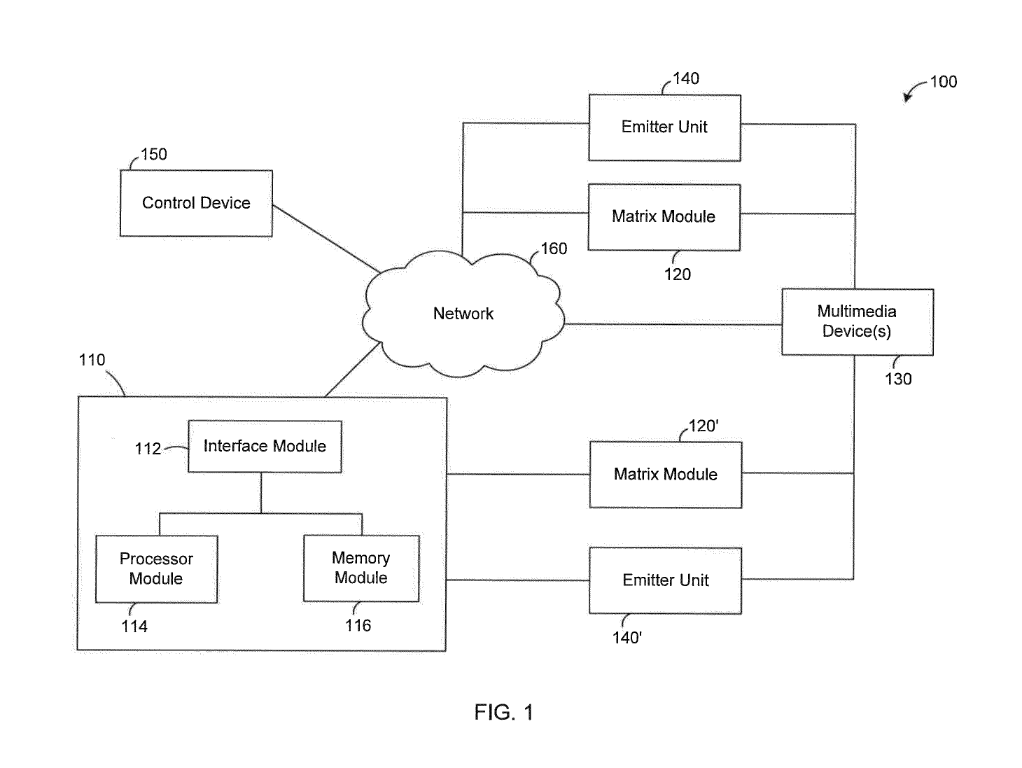

Reference is first made to FIG. 1, therein provided a block diagram of a multimedia network 100 for providing first and second multimedia activities using multiple activity multimedia devices. The multimedia network 100 includes a control system 110, one or more matrix modules 120, 120′, one or more multimedia devices 130, one or more emitter units 140, 140′ and a control device 150. The control system 110, the multimedia devices 130, the emitter unit 140, the matrix module 120 and the control device 150 may communicate over a network 160. Alternatively, the emitter unit 140′ and the matrix module 120′ may be coupled directly with the control system 110 and with the multimedia devices 130.

The control system 110 may include an interface module 112, a processor module 114 and a memory module 116. Each of the interface module 112, the processor module 114 and the memory module 116 may be coupled to each other. The processor module 114 may receive data from and send data to other components of the multimedia network 100 via the interface module 112. The processor module 114 may also communicate with and control the operation of each of the components to which it is coupled.

The memory module 16 may store data received from the interface module 112 and/or the processor module 114. The memory module 116 may include one or more storage devices, or may alternatively access a storage device or medium external to the multimedia network 100. For example, as will be described below, the memory module 116 may store activity profiles for each output multimedia device. Each activity profile may be associated with a unique profile identifier for a multimedia activity on the output multimedia device, one or more activity multimedia devices for providing that multimedia activity, and initialization commands for initiating that multimedia activity. The initialization commands may include device commands for operating an activity multimedia device. In some embodiments, the initialization commands may include IR commands.

The matrix module 120, 120′ may couple each of the multimedia devices 130 within the multimedia network 100 to the control system 110. In some embodiments, the matrix module 120 may couple the multimedia devices 130 to the control system 110 via the network 160. Alternatively, the matrix module 120 may couple the multimedia devices 130 directly to the control system 110.

The matrix module 120 facilitates routing or forwarding of data received from the control system 110 to the indicated, or appropriate, multimedia devices 130. It will be understood that the matrix module 120 may be any multimedia matrix switch configured to receive data via HDMI (High-Definition Multimedia Interface), an Ethernet connection, a component connection (e.g., a RCA connector style head connector), a composite connection (e.g., a RCA connector style head connector), DVI (Digital Visual Interface), a VGA (Video Graphics Array) connection, an analog connection (e.g., a RCA connector style head connector), a TOSLink™ (Toshiba®-Link) connection, or any combination of these. Example HDMI matrix switches may include a 4×4 or a 4×8 matrix switch. In some embodiments, a matrix module 120 may be associated with both video and audio information signals.

In some embodiments, the control system 110 may receive connection information indicating a configuration in which the multimedia activities 130 are connected to the matrix module 120. In some further embodiments, the control system 110 may store the received connection information in the memory module 116. For example, the control system 110 may receive information indicating that a multimedia device 130 is connected to an output terminal A on the matrix module 120 and another multimedia device 130 is connected to an output terminal B on the matrix module 120. In another example, the control system 110 may receive information indicating that two different multimedia devices 130 are connected to one output terminal on the matrix module 120 via a connector capable of splitting a terminal.

The emitter unit 140, 140′ may be coupled to any of the multimedia devices 130 for receiving the initialization commands. Similar to the matrix module 120, the emitter unit 140 facilitates routing or forwarding of data received from the control system 110 to the indicated, or appropriate, multimedia devices 130. Generally, the control system 110 provides a multimedia device 130, via the emitter unit 140, initialization commands based on a communication protocol in compliance with the multimedia device 130. For example, a Bluetooth®-enabled multimedia device 130 may receive initialization commands as Bluetooth signals. Other communication protocols may include radio-frequency (RF), infrared (IR), and other wired or wireless communication technologies.

As illustrated in FIG. 1, the emitter unit 140 may be coupled to the control system 110 via the network 160, or may alternatively be directly coupled to the control system 110 (e.g., emitter unit 140′). It will be understood that although two emitter units 140 and 140′ are illustrated in FIG. 1, the multimedia network 100 may instead include one emitter unit 140. For ease of exposition, two emitter units 140 and 140′ are included in FIG. 1 for illustrative purposes.

In some embodiments, the initialization commands may include IR commands or signals. For forwarding the IR commands, the emitter unit 140 may include an IR emitting device. Generally, the IR emitting device may include any device that can emulate an IR remote control signal, such as, for example, an IR emitter and/or an IR blaster. The IR emitting device may be arranged or located so that the portion of the IR emitting device emitting IR signals is directed at an IR receiver of a multimedia device 130. In some embodiments, the IR emitter may be removably attached or proximally located to an IR receiver on the multimedia device 130. In some embodiments, the IR blaster may be directed towards an IR receiver on the multimedia device 130 and located at a distance away from the multimedia device 130 so that the multimedia device 130 can receive the IR signals. In some further embodiments, the IR emitter device can be oriented, or arranged, so that the IR receiver on the multimedia device 130 receives the IR signals from that IR emitter device at an optimal or desirable level.

Alternatively, an IR extender may extend from a multimedia device 130 for receiving IR commands at a distance away from the multimedia device. The IR extender may be an extension cable or connector connectable to a multimedia device 130, and extending away from that multimedia device for receiving the IR commands. This may be particularly helpful if the multimedia device 130 is stored behind doors or panels and, thus, is unable to receive the IR signals. In some embodiments, an IR emitter may be removably attached or proximally located to an IR extender extending from a multimedia device 130. In some embodiments, an IR blaster may be located away from an IR receiver of the IR extender and directed towards that IR receiver.

In some embodiments, the control system 110 can send the IR signals to the multimedia devices 130 over an HDMI connection and/or over an Ethernet connection. In some other embodiments, the IR signals from the control system 110 can be converted to RF signals to be sent wirelessly to the multimedia devices 130, at which point the RF signals can be converted, or reverted, back to IR signals.

The control device 150 may be any networked computing device that utilizes a processor and memory. A networked device is a device capable of communicating with other devices through a communication network such as network 160. The networked device may couple to the network 160 through a wired or wireless connection. Example networked computing devices include an electronic tablet device, a personal computer, workstation, server, portable computer, mobile device, personal digital assistant, laptop, smart phone, WAP phone, an interactive television, video display terminals, gaming consoles, Blu-ray™ players, DVD players, APPle™ TV, Boxee™ and portable electronic devices, or a combination of these. In some embodiments, the control device 150 may be a networked device configured with a browser associated with a WebKit™ layout engine.

The network 160 may generally be any type of communications network known in the art suitable for carrying data. Example networks 160 include the Internet, Ethernet, plain old telephone service (POTS) line, public switch telephone network (PSTN), integrated services digital 5 network (ISDN), digital subscriber line (DSL), coaxial cable, fiber optics, satellite, mobile, wireless (e.g. Wi-Fi, WiMAX), SS7 signaling network, fixed line, local area network (LAN), wide area network, and others, including any combination of these. In some embodiments, the network 160 may be a private network. For example, the private network may be accessible only via a specific Internet Protocol (IP) address. In some embodiments, the network 160 may be any network (e.g., the Internet) that allows access to the control system 110 from remote locations outside of a LAN in which the control system 110 operates.

The multimedia devices 130 may include any media device that may be used for providing audio and/or visual input and output. As illustrated in FIG. 1, the multimedia devices 130 may be coupled to the matrix module 120, the IR module 140 and/or the network 160. Example multimedia devices 130 include television displays, projector monitors, computer monitors, a DVD player, a Blu-ray player, Apple TV, a digital set top box, personal computers, tablets, smart phones, audio-video equipment (e.g., A/V receivers), gaming consoles, music players, CD players, and other similar devices.

A multimedia device that operates, either individually or in conjunction with one or more multimedia devices, to provide a multimedia activity may be referred to as an activity multimedia device. As well, a multimedia device that provides visual display and/or audio output may be referred to as an output multimedia device. It will be understood that, for each activity, the target output multimedia device may also be referred to as an activity multimedia device since that target output multimedia device also contributes to providing the activity.

Generally, the control system 110 receives control signals for initiating multimedia activities from the control device 150 via the network 160. The control system 110 then processes the control signals to identify the activity profiles in order to determine the activity multimedia devices 130 and initialization commands for providing the multimedia activities.

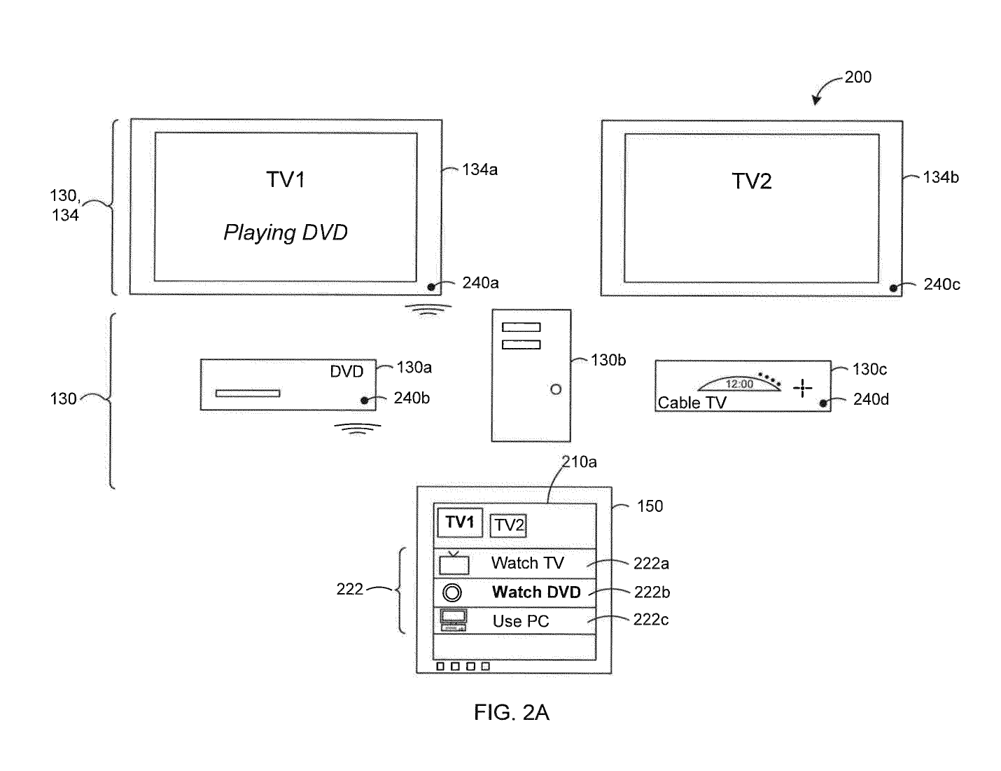

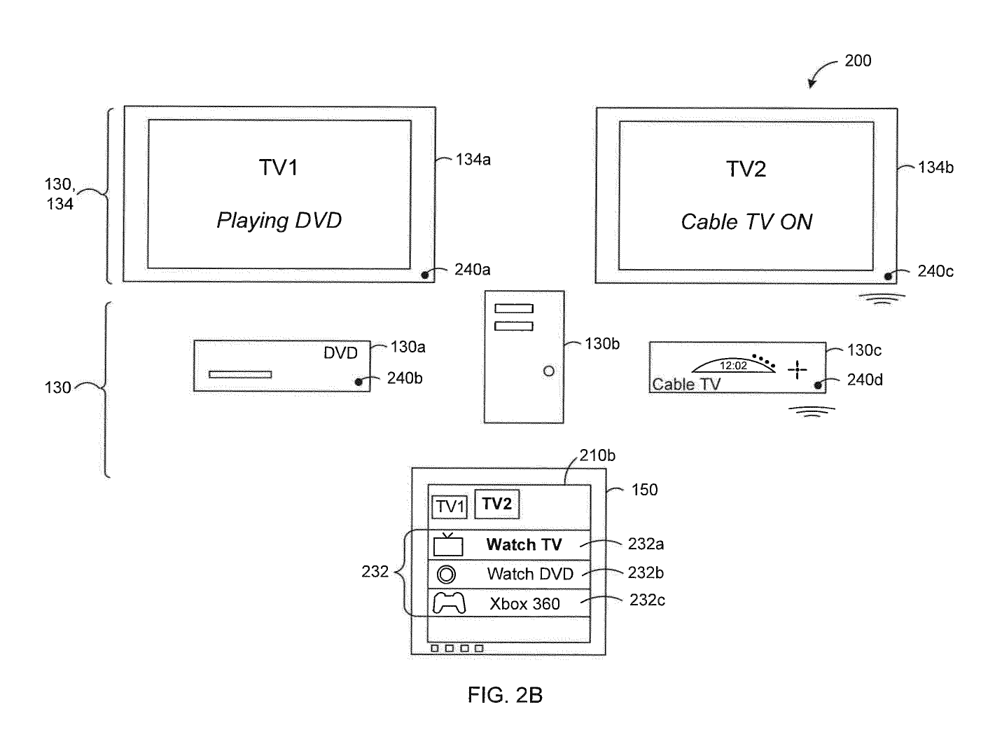

Reference is now made to FIGS. 2A and 2B, therein illustrated an example multimedia network 200 of FIG. 1 providing first and second activities using a plurality of multimedia devices 130. It will be understood that, for ease of exposition, only a limited number of multimedia devices 130 are illustrated in FIGS. 2A and 2B, and that a greater or fewer number of multimedia devices 130 may be provided in the multimedia network 200.

As illustrated in FIG. 2A, several example multimedia devices 130 are provided. The example multimedia devices 130 include two output multimedia devices 134, a first output multimedia device (“TV1”) 134a and a second output multimedia device (“TV2”) 134b, and three other activity multimedia devices 130, a DVD player device 130a, a personal computing (PC) device 130b and a cable TV box device 130c. Also, in this example, each of the first output multimedia device 134a, the second output multimedia device 134b, the DVD player device 130a, and the cable TV box device 130c may receive IR commands at a respective IR receiver 240a to 240d. It will be further understood that the multimedia devices 130 illustrated in FIGS. 2A and 2B are only examples, and that other similar multimedia devices 130 may be used for providing similar multimedia activities, or other multimedia devices 130 may be used for providing other multimedia activities.

In some embodiments, the multimedia devices 130 in the multimedia network 100 may be proximally located, or adjacent, to each other. In some embodiments, the multimedia devices 130 in the multimedia network 100 may be located in separate areas or different rooms. Generally, the control system 110 may receive control signals for providing multimedia activities on multimedia devices 130 that are connected via the matrix module 120, and/or, if that multimedia device 130 receives IR commands, the IR emitting device.

As will be described below, the control system 110 may generate a control interface 210 for each output multimedia device 134. The generated control interfaces 210 may be stored in the memory module 116. The control device 150 may then access the control interface 210 via the network 160. In some embodiments, the control device 150 may access the control interfaces via an IP address associated with the network 160.

Referring still to FIGS. 2A and 2B, a tablet computing device is provided in the multimedia network 200 as an example control device 150. The tablet computing device 150 may access the network 160 via a wireless or an Ethernet connection. As illustrated in FIGS. 2A and 2B, the tablet computing device 150 may access a control interface 210a, 210b, via the network 160, for displaying activities available on, or linked to, each respective output multimedia device 134a, 134b. For example, a list 222 of multimedia activities 222a to 222c linked to the first output multimedia device (TV1) 134a (FIG. 2A) and a list 232 of multimedia activities 232a to 232c linked to the second output multimedia device (TV2) 134b (FIG. 2B) may be provided on the respective control interface 210a, 210b of the tablet computing device 150.

Also for ease of exposition, the control system 110, the matrix module 120, 120′ and the emitter unit 140, 140′ of the multimedia network 200 are not illustrated in FIGS. 2A and 2B. It will be understood that each of the multimedia devices 130 are coupled to the matrix module 120, either directly (e.g., the emitter unit 140) or via the network 160 (e.g., the emitter unit 140). The multimedia devices 130 may receive device commands from the control system 110 via the emitter unit 140 for operating those multimedia devices 130 in the multimedia network 200. The device commands may include IR commands, and the emitter unit 140 may include an IR emitting device. Optionally, the multimedia devices 130 may also be coupled directly to the network 160.

The control system 110 may be provided on the PC device 130b, which may be a networked device. Alternatively, the control system 110 may be provided on another networked computing device not shown in FIG. 2A, such as, for example, a set-top box.

As generally illustrated in FIGS. 2A and 2B, the control system 110 may initiate a first multimedia activity and a second multimedia activity after it receives a first and a second control signal from the tablet computing device 150. In the example shown in FIG. 2A, the control system 110 receives a first control signal indicating that the activity 222b, “Watch DVD”, in the multimedia activities list 222 on the control interface 210 is the multimedia activity for the first output multimedia device 134a. The control system 110 may then provide the first multimedia activity, in accordance with the received first control signal, on the first output multimedia device 134a. The first multimedia activity may involve more than one activity multimedia device 130, such as the first output multimedia device 134a and the DVD player device 130a. The first control signal may, therefore, include initialization commands for operating a plurality of multimedia devices 130 in the multimedia network 200.

With reference now to FIG. 2B, the control system 110 receives a second control signal indicating that the activity 232a, “Watch TV”, in the multimedia activities list 232 on the control interface 210 is the second multimedia activity. The control system 110 may then provide the second multimedia activity on the second output multimedia device 134b based on the received second control signal. Similar to the first multimedia activity, the second multimedia activity may involve more than one activity multimedia device, such as the second output multimedia device 134b and the cable TV box device 130c.

In some embodiments, the control system 110 may receive the second control signal after having received the first control signal. The initialization commands associated with the second control signal for initiating the second activity may be sent to the corresponding activity multimedia devices without affecting the first activity.

In some embodiments, the initialization commands for initiating each multimedia activity may include initialization commands for operating a plurality of activity multimedia devices.

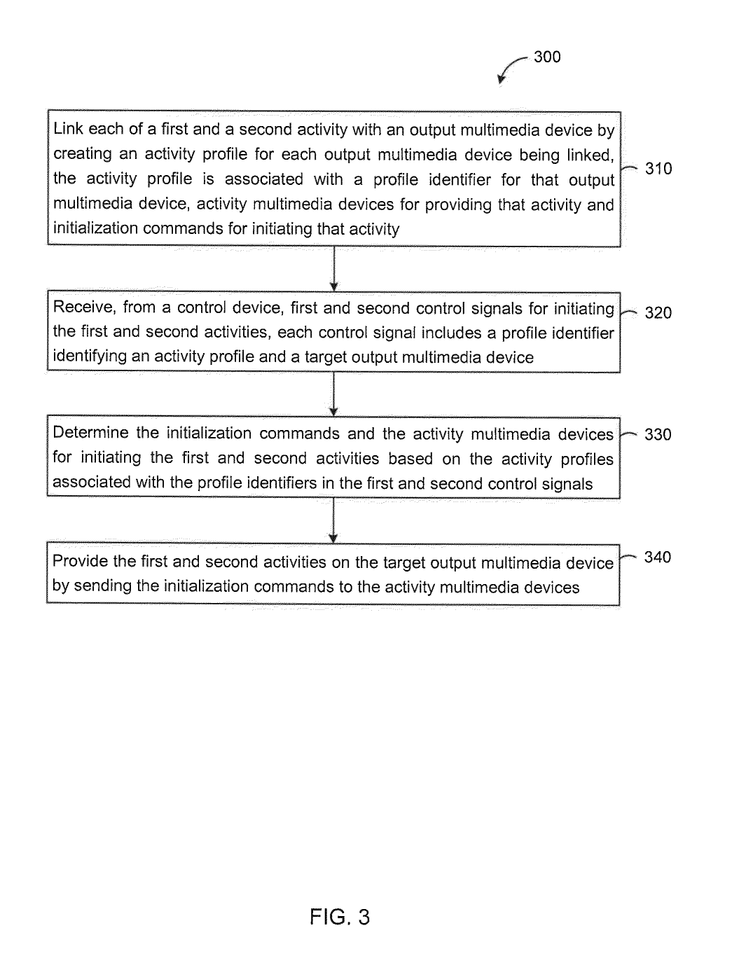

Reference is now made to FIGS. 3 to 12 for describing the steps of providing first and second activities using a plurality of activity multimedia devices. FIG. 3 is a flowchart diagram 300 illustrating the steps of providing first and second activities using a plurality of activity multimedia devices.

At step 310, the processor module 114 links each of a first and second activity with an output multimedia device 134 by creating an activity profile for each output multimedia device 134 being linked.

The control system 110, or in some embodiments the processor module 114, may operate to link any output multimedia device 134 within the multimedia network 100 with a multimedia activity. The control system 110 may add or register each multimedia device 130 into the multimedia network 100. In some embodiments, the control system 110 may add each multimedia device 130 into the multimedia network 100 by storing data corresponding to that multimedia device 130 on the memory module 116.

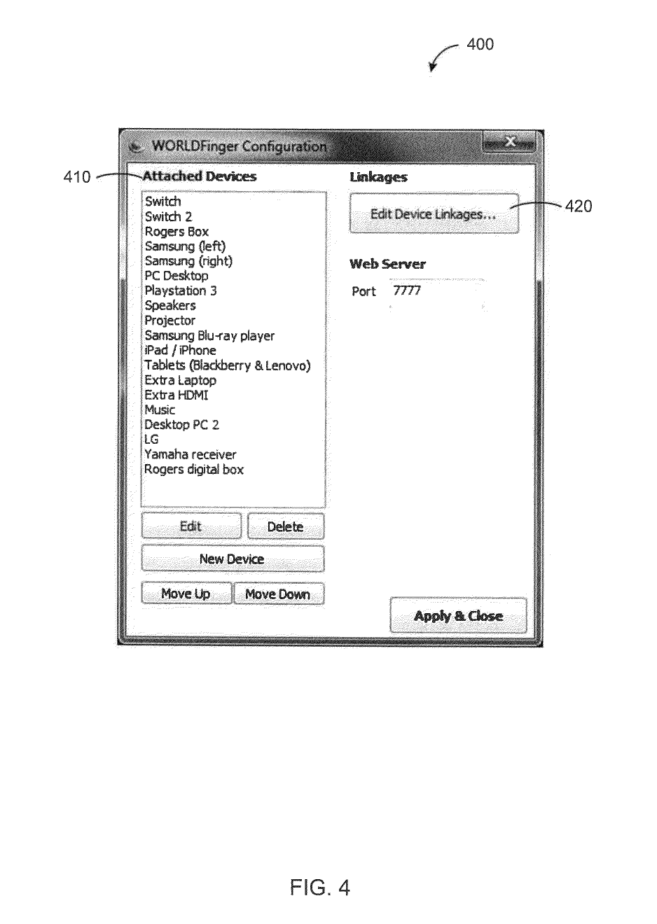

FIG. 4 illustrates an example user interface 400 for configuring multimedia devices 130, or herein referred to as a device configuration interface. For example, the control system 110 may receive an indication from the device configuration interface 400 that a new multimedia device 130 is to be added to the multimedia network 100.

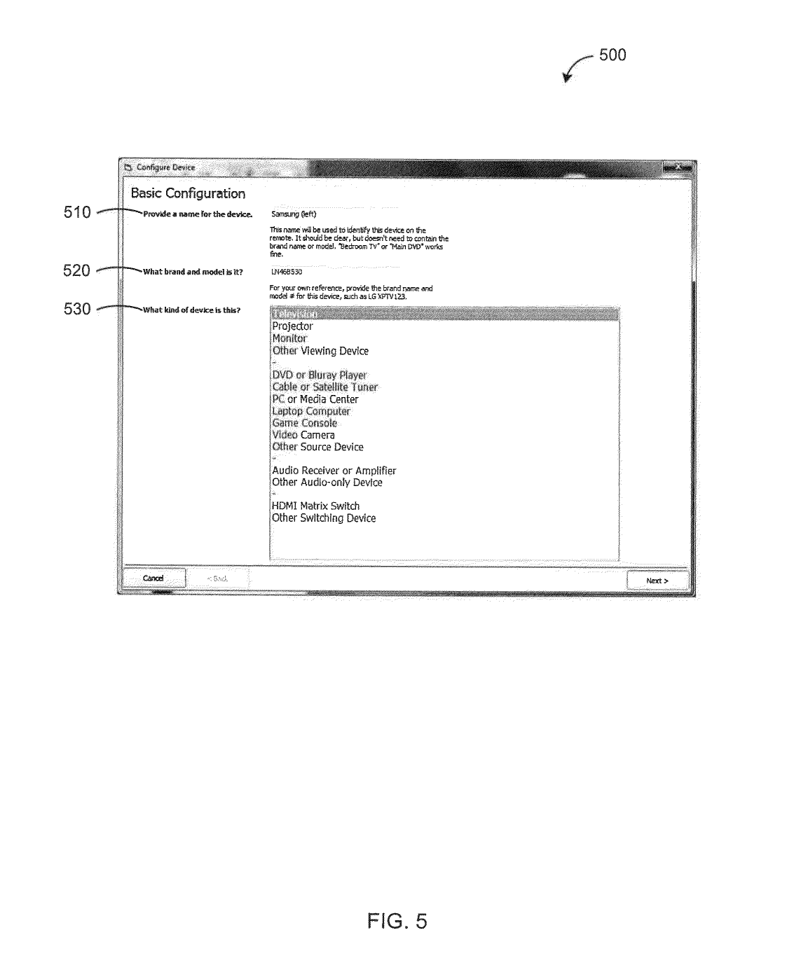

The registration, and/or configuration, of multimedia devices 130 into the multimedia network 100 can be described with reference to FIGS. 5 to 10, which illustrate screenshots of example user interfaces for registering and configuring multimedia devices 130. In some embodiments, the control system 110 may present one or more of the user interfaces illustrated in FIGS. 5 to 10. The device configuration interface 400 may further provide a list 410 of multimedia devices 130 available within, or already added, to the multimedia network 100. In some embodiments, the list 410 may be stored in the memory module 116.

FIG. 5 illustrates a screenshot of a user interface 500 for identifying the multimedia device 130 to be registered into the multimedia network 100 (a device identification interface). General information regarding each multimedia device 130 to be registered and/or configured by the control system 110 may be provided, such as, for example, a name 510 for the multimedia device 130 (a device name), a manufacturer identification 520 of the multimedia device 130 (a device manufacturer ID), and a category 530 of the multimedia device 130 (a device category). In the example shown in FIG. 5, through the device identification interface 500, the control system 110 is receiving information associated with a multimedia device 130 with the device name 510 “Samsung™ (left)”, the device manufacturer ID 520 “LN46B530”, and the device category 530 “Television” for registration into the multimedia network 100.

After the control system 110 receives the identification information of the multimedia device 130 from the device identification interface 500, the control system 110 may continue to request additional information associated with the identified multimedia device 130.

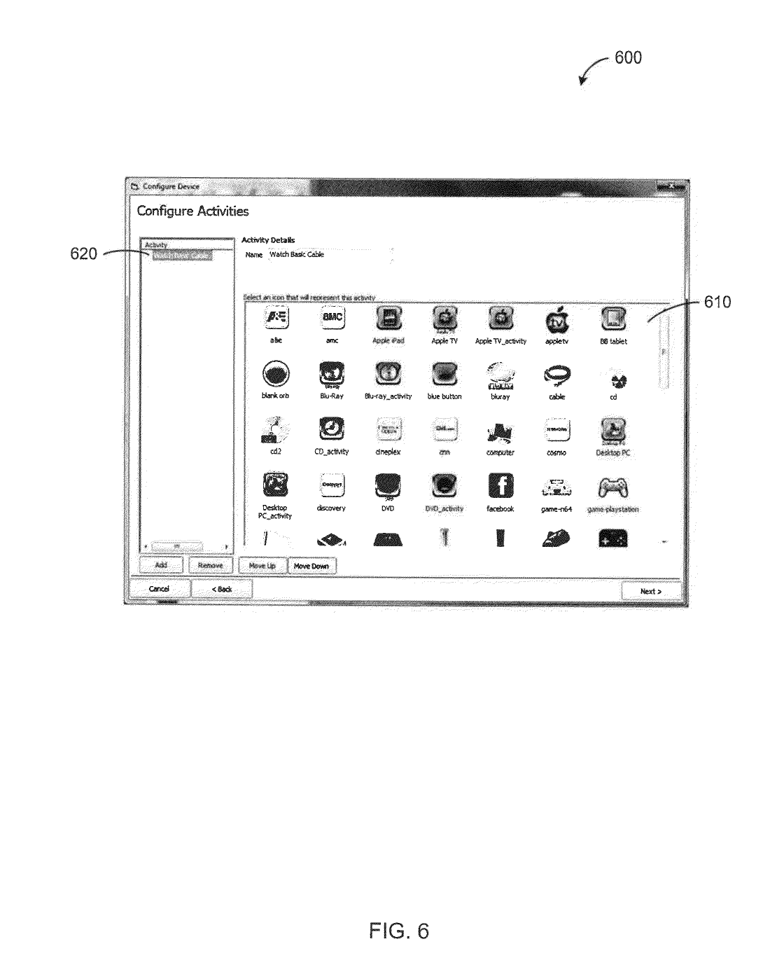

In some embodiments, as illustrated in FIG. 6, the control system 110 may provide a user interface 600 for associating multimedia activities with the identified multimedia device 130, or herein referred to as the activity association interface. In some further embodiments, the control system 110 may provide a library 610 of multimedia activities on the activity association interface 600 from which activities to be associated with the multimedia device 130 may be selected into a list 620 of associated activities.

As described briefly above, multimedia activities generally include any activity that may be provided by one or more multimedia device 130, such as playing a video game, watching a movie or TV, listening to music, browsing the Internet, and other similar activities. The multimedia activities that may be associated with the identified multimedia device 130 may include all or a selection of multimedia activities that may be provided on that multimedia device 130. It will be understood that different multimedia devices 130 may provide the same multimedia activity. For example, the multimedia activity “Watch a Movie” may be provided on a Bluray™ player, a DVD player, or Apple™ TV. In the example shown in FIG. 6, the control system 110 receives information for associating the identified multimedia device 130 with the multimedia activity 620 “Watch Basic Cable”.

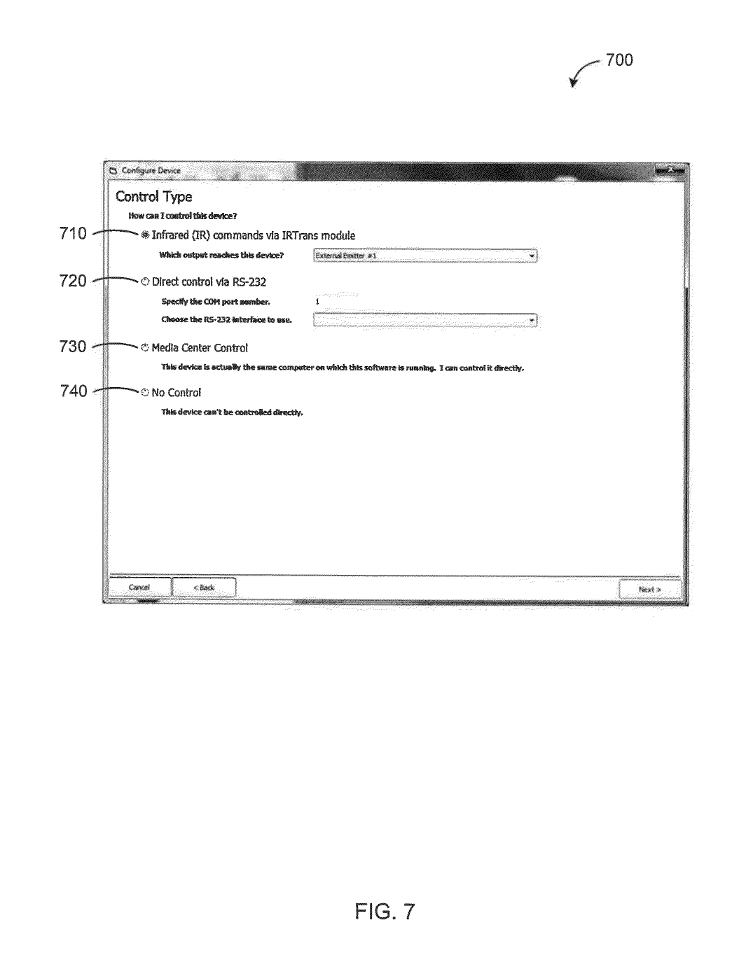

In another example embodiment, as illustrated in FIG. 7, the control system 110 may provide a user interface 700 for indicating how the identified multimedia device 130 may receive commands (a command selection interface). That is, how that identified multimedia device 130 may be operated and/or controlled. In the example command selection interface 700, several radio buttons are available for selection, such as for example, a radio button 710 selectable to indicate that the identified multimedia device 130 receives IR commands (an IR commands button), a radio button 720 selectable to indicate that the identified multimedia device 130 receives commands from the matrix module 120, a radio button 730 selectable to indicate that the identified multimedia device 130 is the computing device on which the control system 110 is provided and thus, may be directly controlled, or a radio button 740 selectable to indicate that the identified multimedia device 130 does not receive external commands.

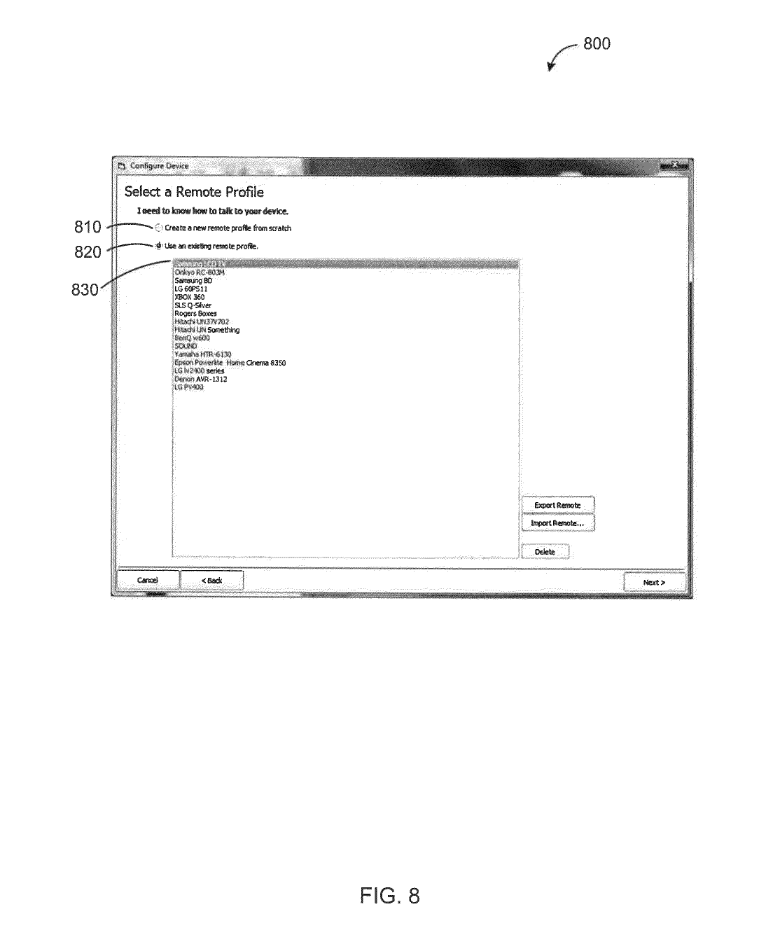

Continuing from FIG. 7, if the control system 110 receives an indication that the IR commands button 710 has been selected, the control system 110 may proceed to associate a remote profile to the identified multimedia device 130, or herein referred to as a device remote profile. The control system 110 may provide a series of user interfaces for receiving information associated with the device remote profile, such as the user interface screenshots illustrated in FIGS. 8 to 10.

Generally, the device remote profile may be created by receiving IR commands for that multimedia device 130, or alternatively, by adopting an existing remote profile. As illustrated in FIG. 8, the control system 110 may facilitate this by providing a user interface 800 for indicating a source of the commands for the device remote profile, or herein referred to as a remote profile source interface. For example, the remote profile source interface 800 may include a radio button 810 selectable to indicate that a new remote profile is to be created (a new remote profile button) and a radio button 820 selectable to indicate that an existing remote profile may be used (an existing remote profile button). If the control system 110 receives an indication that the existing remote profile button 820 has been selected, a list 830 of available remote profiles may be provided for selection. In some embodiments, the list 830 may be stored in the memory module 116.

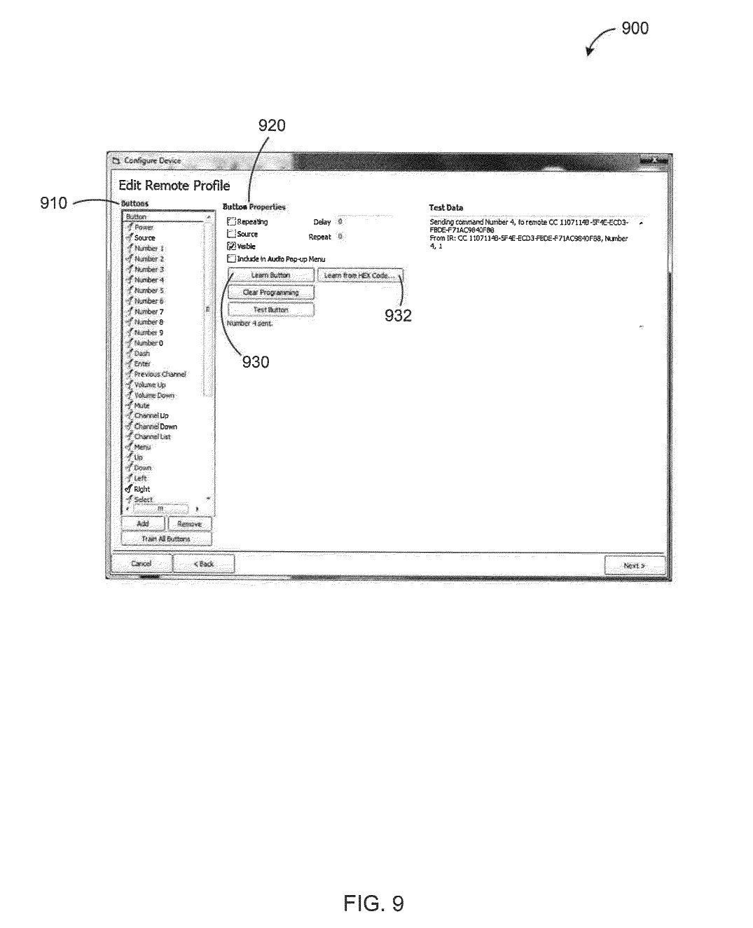

In some embodiments, the control system 110 may continue to provide additional user interfaces for configuring a new or existing remote profile for that identified multimedia device 130. As illustrated in FIG. 9, the control system 110 may provide a user interface 900 for creating and/or modifying a remote profile (a remote profile editing interface). Generally, a control system 110 may create or modify a remote control button when it receives attributes and/or properties for that remote control button and IR commands associated to that remote control button. For example, for a remote profile, a list 910 of remote control buttons may be provided on the remote profile editing interface 900. Each button on the list 910 may be associated with different button properties 920 and IR commands. The IR commands may be learned from a physical remote control for that multimedia device 130 (e,g., when the control system 110 receives an indication that pushbutton 930 is selected) or received as hexadecimal codes (e.g., when the control system 110 receives an indication that pushbutton 932 is selected). In some embodiments, each of the remote control buttons and associated properties may be stored in the memory module 116.

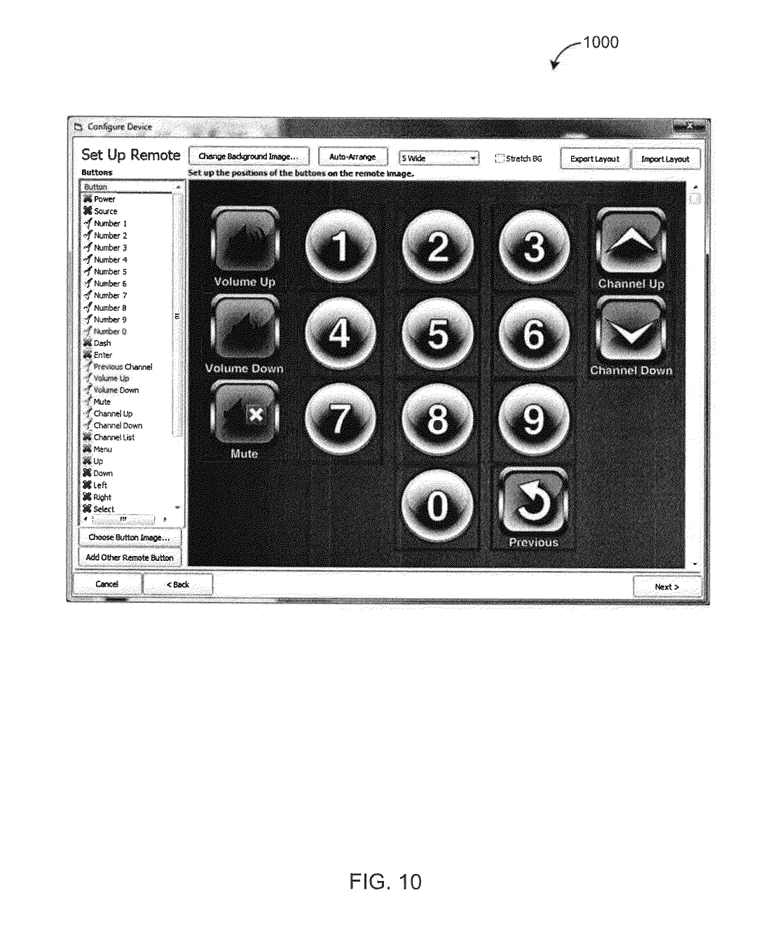

In some further embodiments, as illustrated in FIG. 10, the control system 110 may provide a user interface 1000 for designing a remote interface for that identified multimedia device 130 (a design interface). After each remote control button in a remote profile is associated with corresponding IR commands, the remote control buttons in the remote profile may be arranged to be used as the remote interface for that multimedia device 130. The remote interface may be configured to include a keyboard, keypad, volume controls, channel controls and/or any other remote control interface buttons.

In some embodiments, the control system 110 may provide the remote interface, via the network 160, onto the control device 150. In some further embodiments, the remote interface may include one or more user interface controls, such as the remote control buttons, that are capable of being manipulated for selecting a command for operating that multimedia device.

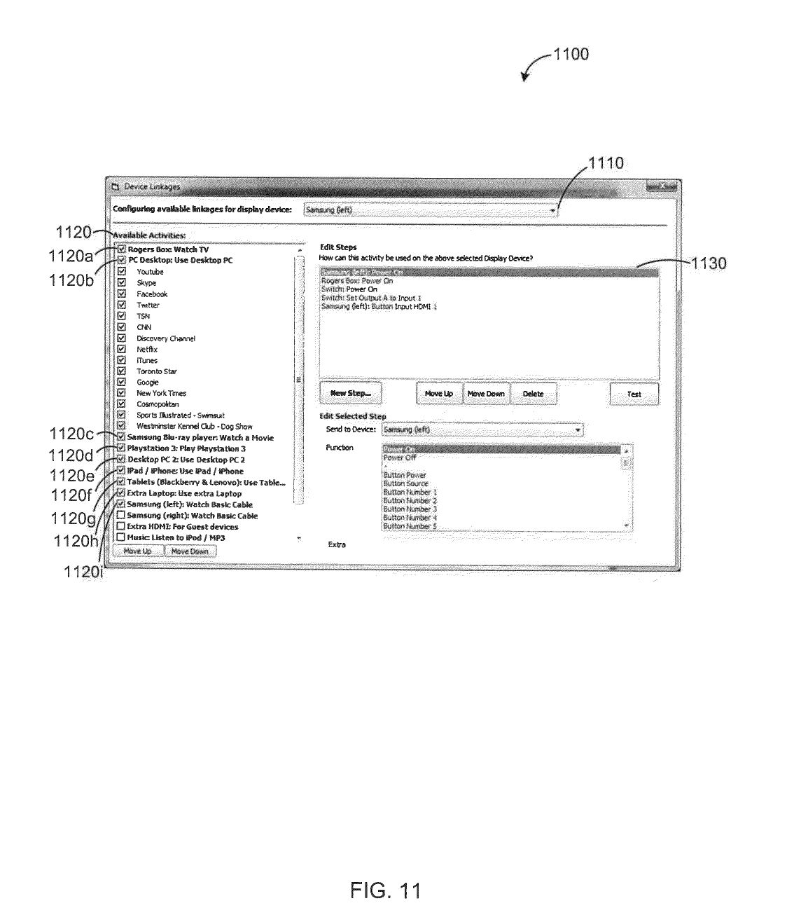

Referring again to FIG. 4, after multimedia devices 130 are added to the multimedia network 100, the control system 110 may also receive an indication from the device configuration interface 400 that a pushbutton 420 for linking multimedia activities to output multimedia devices 134 is selected. As illustrated in FIG. 11, the control system 110 may then provide a user interface 1100 for linking activities with output multimedia devices 134, or herein referred to as a linking interface,

To link a multimedia activity with an output multimedia device 134, the control system 110 may create an activity profile for that output multimedia device 134. As described briefly above, the activity profile may generally be associated with a profile identifier identifying the multimedia activity and the output multimedia device 134, activity multimedia devices 130 needed for providing that multimedia activity and initialization commands for initiating that multimedia activity. The initialization commands may include an IR command. As shown in FIG. 11, the linking interface 1100 may include a dropdown list 1110 from which an output multimedia device 134 may be selected to be linked (a output device dropdown list), a list 1120 of multimedia activities selectable to be linked to the output multimedia device 134 selected in the output device dropdown list 1110 (an activity list), and a sequence 1130 of initialization commands for providing a corresponding activity on the activity list 1120 (a initialization command sequence).

In some embodiments, a multimedia activity may be linked with more than one output multimedia device 134.

For example, referring now to FIG. 11, the control system 110 has received an indication that the output multimedia device 134 identified by the device name 510 “Samsung (left)” has been selected in the output device dropdown list 1110. The control system 110 has similarly received indications that activities 1120a to 1120i in the activity list 1120 have been selected to be linked to the device “Samsung (left)”, It will be understood that fewer or more activities may be selected to be linked to an output multimedia device 134. An example initialization command sequence 1130 for providing the activity 1120a (e.g., “Rogers® Box: Watch TV”) is illustrated in the linking interface 1100. The example initialization command sequence 1130 includes turning on the “Samsung (left)” device, turning on a device identified by the name “Rogers Box”, turning on the matrix module 120, assigning an output terminal on the matrix module 120 to an input terminal so that data from the “Rogers Box” device may be provided onto the “Samsung (left)” device, and sending a signal to the “Samsung (left)” device to receive input from the corresponding input terminal on the matrix module 120. Accordingly, in this example, to provide the activity 1120a, each of these initialization commands in the example initialization command sequence 1130 may be transmitted or sent to the corresponding multimedia devices 130.

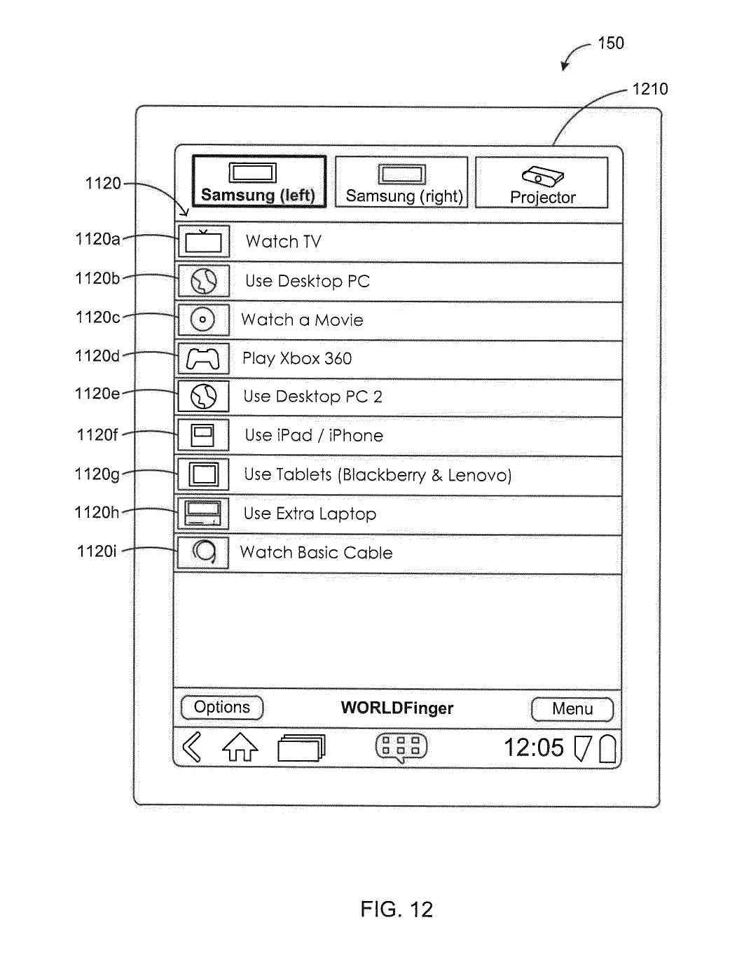

A control interface 210 for the “Samsung (left)” device may be provided on the control device 150 via the network 160. Referring now to FIG. 12, therein illustrated an example control device 150. After the multimedia activities 1120a to 1120i are linked to the “Samsung (left)” device, the control system 110 may provide, via the network 160, a corresponding control interface 1210 on the control device 150. Similar to the control interfaces 210a and 210b illustrated in FIGS. 2A and 2B, respectively, the control interface 1210 may provide all multimedia activities 1120a to 1120i linked to the “Samsung (left)” device in the linking interface 1100.

In some embodiments, each of the multimedia activities 1120a to 1120i provided on the control interface 1210 may be associated with a user interface control (an activity control button). The activity control buttons on the control interface 1120 may be capable of being manipulated for selecting an activity to be initiated. The control system 110 may thereafter receive a control signal corresponding to the activity associated with the selected activity control button.

Referring again to FIGS. 2A and 2B, the control system 110 may add, or register, the first output multimedia device (“TVI”) 134a, the second output multimedia device (“TV2”) 134b, the DVD player device 130a, the personal computing device 130b and the cable TV box device 130c into the multimedia network 200. After each of these multimedia devices 130 are added to the multimedia network 200, the first and second output multimedia devices 134a, 134b may be linked with various available multimedia activities, as described above with reference to FIGS. 4 and 11.

As illustrated in the control device 150, a control interface 210a, 210b is available for each of the first output multimedia device 134a (FIG. 2A) and the second output multimedia device 134b (FIG. 2B). Each of the control interfaces 210a, 210b may include a list 222, 232, respectively, of multimedia activities linked to the respective output multimedia device 134a, 134b. As described above with reference to FIG. 11, each of the multimedia activity in the lists 222, 232 correspond to an activity profile. For example, in FIG. 2A, the multimedia activities available on, or linked to, the first output multimedia device 134a include “Watch TV” 222a, “Watch DVD” 222b, and “Use PC” 222c, and in FIG. 2B, the multimedia activities available on, or linked to, the second output multimedia device 134b include “Watch TV” 232a, “Watch DVD” 232b, and “Xbox 360®” 232c.

An activity profile corresponding to the “Watch TV” activity 222a is, therefore, associated with the first output multimedia device 134a. In order for the control system 110 to provide the “Watch TV” activity 222a on the first output multimedia device 134a, the “Watch TV” activity 222a may also be associated with the cable TV box device 130c. Similarly, an activity profile corresponding to the “Watch TV” activity 232a is associated with the second output multimedia device 134b, and may further be associated with the cable TV box device 130c in order for the control system 110 to provide the “Watch TV” activity 232a on the second output multimedia device 134b.

Each of the activity profiles corresponding to the “Watch DVD” activities 222b and 232b are each associated with the respective first output multimedia device 134a and second output multimedia device 134b, and may similarly be associated with the DVD player device 130a in order for the control system 110 to provide the “Watch DVD” activity 222b, 232b.

An activity profile corresponding to the “Use PC” activity 222c is associated with the first output multimedia device 134a and may further be associated with the PC device 130b in order for the control system 110 to provide the “Use PC” activity 222c. In some embodiments, the remote interface for the “Use PC” activity 222c may include a keyboard. In some embodiments, the remote interface for the “Use PC” activity 222c may include interface controls capable of being selected for initiating a software application or program available on that PC, such as, for example, an e-mail client (e.g., Microsoft Outlook™), a web browser, a messenger application (e.g., Skype®), or a remote access program. For example, an interface control may be associated with a hyperlink so that once the control system 110 receives a control signal indicating that the interface control is selected, the control system 110 initiates a web browser directed to a corresponding web address. In another example, an interface control may be associated with remote access to the PC so that once the control system 110 receives a control signal indicating that the remote access interface control is selected, the control system 110 initiates remote access to that PC on the control device 150.

Furthermore, an activity profile corresponding to the “Xbox 360” activity 232c is associated with the second output multimedia device 134b and may further be associated with a Xbox 360 console (not shown) within the multimedia network 200 in order for the control system 110 to provide the “Xbox 360” activity 232c. In some embodiments, the remote interface for the “Xbox 360” activity 232c may include interface controls corresponding to controls on a game console.

In some embodiments, a multimedia activity may be concurrently provided on the control device 150 and the target output multimedia device 134. For example, if the control system 110 receives a control signal indicating that the “Use PC” activity 222c is to be provided on the first output multimedia device 134a, the control system 110 may operate to provide the “Use PC” activity 222c on both the first output multimedia device 134a and the control device 150. The control system 110 may further receive commands associated with the “Use PC” activity 222c on the control device 150.

Also described above with reference to FIG. 11, each of the activity profiles corresponding to the activities 222a to 222c, 232a to 232c linked to the first output multimedia device 134a and the second output multimedia device 134b may further be associated with initialization commands for providing the activities.

At step 320, the interface module 112 receives, from a control device 150, first and second control signals for initiating the first and second activities.

The control system 110 may operate to initiate multimedia activities in accordance with received control signals. Each control signal may include a profile identifier for identifying an activity profile and a target output multimedia device 134 on which the multimedia activity is to be provided.

For example, referring again to FIG. 2A, the interface module 112 may receive a first control signal indicating that the activity control button corresponding to the “Watch DVD” activity 222b on the control device 150 has been selected. That is, the multimedia activity corresponding to the first control signal is to “Watch DVD” on the first output multimedia device 134a. Continuing with FIG. 2B, the interface module 112 may receive a second control signal indicating that the activity control button corresponding to the “Watch TV” activity 232a on the control device 150 has been selected. That is, the multimedia activity corresponding to the second control signal is to “Watch TV” on the second output multimedia device 134b.

In some embodiments, the interface module 112 may receive the second control signal after receiving the first control signal.

At step 330, the processor module 114 determines the initialization commands and the activity multimedia devices 130 for initiating the first and second activities based on the activity profiles associated with the profile identifiers provided in the first and second control signals.

After the interface module 112 receives the first and second control signals, the processor module 114, which is coupled to the interface module 112, may determine the initialization commands and activity multimedia devices 130 based on the activity profiles associated with the profile identifiers provided in the first and second control signals.

For example, with reference to FIG. 2A, after the first control signal corresponding to the “Watch DVD” activity 222b is received at the interface module 112, the processor module 114 determines the initialization commands and activity multimedia devices 130 associated with that activity profile. Similar to the above example described with reference to FIG. 11, the processor module 114 may determine that the activity profile for the “Watch DVD” activity 222b is associated with the first output multimedia device 134a and the DVD player device 130a. The processor module 114 may further determine that the initialization commands may include commands for initiating the “Watch DVD” activity 222b, such as, for example, turning on the first output multimedia device 134a and the DVD player device 130a, sending a “play” command to the DVD player device 130a to start playing a DVD, and configuring input and output terminals on the matrix module 116 so that the DVD is provided on the first output multimedia device 134a. It will be understood that other initialization commands may be used for initiating the “Watch DVD” activity 222b.

Continuing the above example and with reference to FIG. 2B, after the second control signal corresponding to the “Watch TV” activity 232a is received at the interface module 112, the processor module 114 determines the initialization commands and activity multimedia devices 130 associated with that activity profile. Similar to the example described with reference to FIG. 11, the processor module 114 may determine that the activity profile for the “Watch TV” activity 232a is associated with the second output multimedia device 134b and the cable TV box device 130c. The processor module 114 may further determine that the initialization commands include commands for initiating the “Watch TV” activity 232a, such as, for example, turning on the second output multimedia device 134a and the cable TV box device 130c, and configuring an input terminal and an output terminal on the matrix module 116 so that data from the cable TV box device 130c may be provided on the second output multimedia device 134b. It will be understood that other initialization commands may be used for initiating the “Watch TV” activity 232a.

At step 340, the processor module 112 provides the first and second activities on the target output multimedia devices 134 by sending the initialization commands to the corresponding activity multimedia devices 130.

As described above, the processor module 112 may determine that the initialization commands for initiating a multimedia activity include device commands. In some embodiments, the processor module may send the device commands of the determined initialization commands to the corresponding activity multimedia devices via the emitter unit 140 and the remaining initialization commands of the determined initialization commands via the matrix module 120. In some further embodiments, the initialization commands may include IR commands. The IR commands may be sent to the corresponding multimedia device via an emitter unit 140 that includes an IR emitting device.

Referring again to FIG. 2A, each of the activity multimedia devices 130 associated with the first and second multimedia activities, that is, the “Watch DVD” activity 222b and the “Watch TV” activity 232a, may receive IR commands, as indicated by the IR receivers 240a to 240d on the respective activity multimedia devices 130. Therefore, in the example illustrated in FIGS. 2A and 2B, the processor module 112 may send the IR commands for initiating the first and second activities on the respective output multimedia devices 134a, 134b to the activity multimedia devices 130 (e.g., the first output multimedia device 134a, the second output multimedia device 134b, the DVD player device 130a, and the cable TV box device 130c) via the emitter unit 140 that includes an IR emitting device, and may send the other initialization commands via the matrix module 120.

The present invention has been described here by way of example only. Various modification and variations may be made to these exemplary embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

1. A method of providing first and second activities using a plurality of multimedia devices, the method comprising:
linking each of the first and second activities with at least one output multimedia device by creating an activity profile for each output multimedia device being linked, the activity profile being associated with a profile identifier for that output multimedia device, one or more activity multimedia devices for providing that activity and initialization commands for initiating that activity, wherein at least one initialization command is an infrared (IR) command;
receiving, from a control device, first and second control signals for initiating the first and second activities, each control signal comprising a profile identifier for identifying an activity profile and a target output multimedia device;
determining the initialization commands and the activity multimedia devices for initiating the first and second activities based on the activity profiles associated with the profile identifiers provided in the received first and second control signals; and
providing each of the first and second activities on the corresponding target output multimedia device by sending the determined initialization commands to the activity multimedia devices, wherein the IR commands of the determined initialization commands are sent via an IR emitting device and the remaining initialization commands of the determined initialization commands are sent via a matrix module.

2. The method of claim 1, wherein the second control signal is received after receiving the first control signal and the initialization commands for initiating the second activity are sent to the corresponding activity multimedia devices without affecting the first activity.

3. The method of claim 2, wherein the initialization commands for initiating an activity comprise initialization commands for operating a plurality of activity multimedia devices.

4. The method of claim 3, wherein the plurality of multimedia devices are located proximally to each other.

5. The method of claim 2, wherein the IR commands are sent to one or more activity multimedia device that receives IR commands via a corresponding one or more IR emitting device, each activity multimedia device being associated with an IR receiver for receiving IR commands and each IR emitting device being located proximally to an IR receiver of an activity multimedia device.

6. The method of claim 1, wherein the control device and the IR emitting device are configured to communicate via a network.

7. The method of claim 6, wherein the network is a private network.

8. The method of claim 1 further comprises receiving connection information indicating a configuration in which the plurality of activity multimedia devices are connected to the matrix module, wherein the plurality of activity multimedia devices are accessible via the matrix module.

9. The method of claim 1 further comprises generating a user interface for each multimedia device of the plurality of activity multimedia devices and providing the user interface via the control device, wherein each user interface comprises at least one user interface control capable of being manipulated for selecting a control signal for operating the corresponding multimedia device.

10. A system for providing first and second activities using a plurality of multimedia devices, the system comprising:
a memory module operable to store a plurality of activity profiles for a plurality of output multimedia devices, each activity profile being associated with a profile identifier for a corresponding output multimedia device, one or more activity multimedia devices for providing that activity and initialization commands for initiating that activity, wherein at least one initialization command is an infrared (IR) command;
an interface module operable to receive, from a control device, first and second control signals for initiating the first and second activities, each control signal comprising a profile identifier for identifying an activity profile and a target output multimedia device; and
a processor module operable to link each of the first and second activities with at least one output multimedia device by creating an activity profile for each output multimedia device being linked;
determine the initialization commands and the activity multimedia devices for initiating the first and second activities based on the activity profiles associated with the profile identifiers provided in the received first and second control signals; and
provide each of the first and second activities on the corresponding target output multimedia device by sending initialization commands to activity multimedia devices, wherein the IR commands of the determined initialization commands are sent via an IR emitting device and the remaining initialization commands of the determined initialization commands are sent via a matrix module.

11. The system of claim 10, wherein the second control signal is received after receiving the first control signal and the initialization commands for initiating the second activity are sent to the corresponding activity multimedia devices without affecting the first activity.

12. The system of claim 11, wherein the initialization commands for initiating an activity comprise initialization commands for operating a plurality of activity multimedia devices.

13. The system of claim 12, wherein the plurality of multimedia devices are located proximally to each other.

14. The system of claim 11, wherein the IR commands are sent to one or more activity multimedia device that receives IR commands via a corresponding one or more IR emitting device, each activity multimedia device being associated with an IR receiver for receiving IR commands and each IR emitting device located proximally to an IR receiver of an activity multimedia device.

15. The system of claim 10, wherein the control device and the IR emitting device are configured to communicate via a network.

16. The system of claim 15, wherein the network is a private network.

17. The system of claim 10, wherein the interface module is further operable to receive connection information indicating a configuration in which the plurality of activity multimedia devices are connected to the matrix module, wherein the plurality of activity multimedia devices are accessible via the matrix module.

18. The system of claim 10, wherein the processor module is further operable to generate a user interface for each multimedia device of the plurality of activity multimedia devices and providing the user interface via the control device, wherein each user interface comprises at least one user interface control capable of being manipulated for selecting a control signal for operating the corresponding multimedia device.

19. A method of providing first and second activities using a plurality of multimedia devices, the method comprising:
linking each of the first and second activities with at least one output multimedia device by creating an activity profile for each output multimedia device being linked, the activity profile being associated with a profile identifier for that output multimedia device, one or more activity multimedia devices for providing that activity and initialization commands for initiating that activity, wherein at least one initialization command is a device command for operating an activity multimedia device;
receiving, from a control device, first and second control signals for initiating the first and second activities, each control signal comprising a profile identifier for identifying an activity profile and a target output multimedia device;
determining the initialization commands and the activity multimedia devices for initiating the first and second activities based on the activity profiles associated with the profile identifiers provided in the received first and second control signals; and
providing each of the first and second activities on the corresponding target output multimedia device by sending the determined initialization commands to the activity multimedia devices, wherein the device commands of the determined initialization commands are sent via the emitter unit and the remaining initialization commands of the determined initialization control commands are sent via a matrix module.

20. The method of claim 19, wherein the second control signal is received after receiving the first control signal and the initialization commands for initiating the second activity are sent to the corresponding activity multimedia devices without affecting the first activity.
